(19) United States
(12) Patent Application Publication
(10) Pub. No.: US 2024/0206586 A1
(43) Pub. Date: Jun. 27, 2024

(54) HEALTH-PROMOTING FUNCTIONAL SHOE HAVING FUNCTION OF STIMULATING SOLAR PLEXUS POINT

(71) Applicant: SHOEALLS CO., LTD., Cheonan-si (KR)

(72) Inventor: Cheong Geun LEE, Cheonan-si (KR)

(21) Appl. No.: 18/461,870

(22) Filed: Sep. 6, 2023

(30) Foreign Application Priority Data
Dec. 26, 2022 (KR) 10-2022-0184120

(51) Int. Cl. A43B 7/1455; A61H 23/02; A61H 39/04

(52) U.S. Cl. CPC A43B 7/146; A61H 23/02; A61H 39/04; A61H 2201/1642; A61H 2201/165; A61H 2205/125

(57) ABSTRACT

Proposed is a health-promoting functional shoe having a function of stimulating a solar plexus point. The functional shoe includes un upper, a middle sole disposed on a bottom surface of the upper, an outsole disposed on a bottom surface of the middle sole, a recess recessed downward in an area corresponding to a sole of a forefoot of a wearer or a sole of a hindfoot of the wearer, or both, on an upper surface of the middle sole, a vibration unit disposed to be inserted into the recess, and an acupressure unit including receiving space portions formed to be concave downward while being disposed in a form surrounding the vibration unit on the upper surface of the middle sole, and elastic springs each fitted into individual receiving space portions.

### CROSS REFERENCE TO RELATED APPLICATION

The present application claims priority to Korean Patent Application No. 10-2022-0184120, filed Dec. 26, 2022, the entire contents of which is incorporated herein for all purposes by this reference.

### BACKGROUND OF THE INVENTION

### Field of the Invention

The present disclosure relates to a functional shoe and, more particularly, to a health-promoting functional shoe having a function of stimulating a solar plexus point with improved vibration and acupressure structures and a coupling and arrangement structure therebetween to stimulate the solar plexus reflex point located on the sole of a wearer's foot, thereby helping to improve blood flow, protect joints, and promote health.

The research project supporting the present disclosure is as follows:

Project No .: S3363671

Project Serial No .: 3363671

Government Ministry: Ministry of Small and Medium-Sized Enterprises and Startups

Project Management Institution: Korea Technology and Information Promotion Agency for SMEs

Research Project Name: Customized business support (2023 Support business for growth of Busan local businesses)

Research Topic: Reduction by 93% of defect rate in sealing low-frequency generating vibration module for functional shoes

Contribution Ratio: 1/1

Supervision Institution: Busan Technopark

Research Period: Aug. 1, 2023 to Oct. 31, 2023 (Duration of Agreement)

### Description of the Related Art

In general, functional health shoes are designed to contribute to health promotion by including functionality in shoes typically consisting of an upper part that protects the wearer's foot and an outsole provided on the lower surface of the upper part to protect the foot against the ground.

For example, in recent years, various functional shoes have been proposed and used, such as a shoe that enables rolling motion, that is, Masai walking, by realizing an outsole of the shoe in an arc shape, a shoe with a function to prevent slipping, and a shoe that better absorbs shock generated during walking.

Since these functional shoes are manufactured according to the intended functions, they will undoubtedly have a positive effect on the wearer's health. However, in line with the well-being era, new functional shoes that further contribute to the wearer's health enhancement in more diverse ways are required. As an example, a functional shoe that helps improve health by improving blood flow is proposed in Korean Patent No. 10-1121540 (registered on Feb. 22, 2012, hereinafter referred to as “Document 1”) “FUNCTIONAL HEALTH SHOE HAVING VIBRATION DEVICE FOR IMPROVEMENT OF BLOODSTREAM”.

The Document 1 discloses a technology regarding a functional health shoe equipped with a vibration device for improving blood flow. The shoe not only absorbs shock as the shape thereof changes due to external pressure generated during walking, but also stimulates interest in walking as vibration and magnetic force are generated by the repulsive force of a magnet, and at the same time, improves blood flow by stimulating acupoints.

Another example is proposed in Korean Patent No. 10-1198699 (registered on Nov. 01, 2012, hereinafter referred to as “Document 2”) “SHOE WITH BUILT-IN VIBRATION GENERATING BUFFERING MEANS”.

The Document 2 discloses a shoe composed of an outsole with a midsole and an insole with an upper, wherein a separate vibration generating and buffering means is placed on the upper part of the outsole, and the midsole is formed with a through hole allowing the upper part of the vibration generating and buffering means to protrude while the insole is provided with a receiving part allowing the upper part of the vibration generating and buffering means to protrude, so that the shocks of walking that directly act on the human body through the heel is effectively reduced, significantly reducing pain and fatigue even when wearing the shoe for a long time. In addition, a vibration generation unit, acting by the pressing force of the user's weight, induces vibration so that the contraction and relaxation of muscle cells are repeated to create a continuous massage effect for the feet where the weight is concentrated, reducing the fatigue of the feet and preventing swelling of the feet. Moreover, since the vibration action that arouses the user's interest doubles the pleasure of wearing the shoe and walking, the shoe may contribute to health as the user's activity increases.

Yet another example is proposed in Korean Patent No. 10-1231022 (registered on February 01, 2013, hereinafter referred to as “Document 3”) “SHOE WITH BUILT-IN VIBRATION GENERATING MEANS”.

The Document 3 discloses a shoe in which a vibration generating means having a magnet body that vibrates innumerably up and down by mutual repulsive force is embedded in the forefoot of the shoe. In the shoe, on the upper part of an outsole, an elastic member layer and a midsole of compressed pulp, and a cushion member layer and an insole of liner are sequentially formed, wherein an accommodation groove for embedding the vibration generating means is formed in the elastic member layer and the midsole, so that, due to the countless vibration force generated from the vibration generating means, pain and fatigue of the feet are remarkably reduced, and the vibration generating means acting by the shocks of walking induces vibration so that the contraction and relaxation of muscle cells are repeated to create a continuous massage effect for the feet where the weight is concentrated, reducing the fatigue of the feet and preventing swelling of the feet by improving blood flow. In addition, by inducing smooth blood circulation, it is possible to prevent the occurrence of discomfort or unpleasant odor due to heat in the toe area, thereby preventing bacterial proliferation and various foot-related diseases. Moreover, since the vibration action that arouses the user's interest doubles the pleasure of wearing the shoe and walking, the shoe may contribute to health as the user's activity increases.

Documents of Related Art

(Patent Document 0001) Korean Patent No. 10-1121540 (registered on February 22, 2012) (Patent Document 0002) Korean Patent No. 10-1198699 (registered on November 01, 2012) (Patent Document 0003) Korean Patent No. 10-1231022 (registered on February 01, 2013)

### SUMMARY OF THE INVENTION

Accordingly, the present disclosure has been made keeping in mind the above problems occurring in the related art, and the present disclosure is intended to provide a health-promoting functional shoe having a function of stimulating a solar plexus point with improved arrangement and fixing structure to prevent a vibration unit from escaping from a casing when a wearer walks.

Furthermore, the present disclosure is intended to provide a health-promoting functional shoe having a function of stimulating a solar plexus point that helps improve health by stimulating the solar plexus reflex point located on the sole of the wearer's foot.

In addition, the present disclosure is intended to provide a health-promoting functional shoe having a function of stimulating a solar plexus point that helps improve blood flow and protect joints by simultaneously providing the effects of vibration and acupressure.

In order to achieve the above objective, according to an aspect of the present disclosure, there is provided a health-promoting functional shoe having a function of stimulating a solar plexus point, the functional shoe including: un upper, a middle sole disposed on a bottom surface of the upper, an outsole disposed on a bottom surface of the middle sole, a recess recessed downward in an area corresponding to a sole of a forefoot of a wearer or a sole of a hindfoot of the wearer, or both, on an upper surface of the middle sole, a vibration unit disposed to be inserted into the recess, and an acupressure unit including receiving space portions formed to be concave downward while being disposed in a form surrounding the vibration unit on the upper surface of the middle sole, and elastic springs each fitted into individual receiving space portions. According to a health-promoting functional shoe having a function of stimulating a solar plexus point of the present disclosure, it is possible to absorb the shocks generated during walking to ensure comfortable walking, make walking more enjoyable by arousing the wearer's interest due to the vibration, and promote health by improving blood flow, that is, stimulating acupoints on the sole of the foot and promoting blood circulation since magnetic force is transmitted more effectively, that is, a magnetic field is generated when vibrating.

In addition, since the solar plexus reflex point on the sole of the wearer's foot is stimulated by using a magnet, it is possible to clear energy blockages and facilitate physical activation.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an exploded three-dimensional configuration diagram showing a health-promoting functional shoe having a function of stimulating a solar plexus point according to an embodiment of the present disclosure;

FIG. 2 is a plan view of FIG. 1;

FIG. 3 is a partial coupling cross-sectional configuration diagram of FIG. 1;

FIG. 4 is an overall configuration diagram showing a vibration unit;

FIG. 5 is a three-dimensional configuration diagram showing a vibration frame and first and second vibration plates;

FIG. 6 is a plan view of FIG. 5;

FIG. 7 is a plan configuration diagram showing each vibration plate and vibration means disposed in a bottom housing of a casing;

FIG. 8 is an overall cross-sectional configuration diagram showing the vibration unit; and

FIG. 9 is an overall cross-sectional view showing the operating state of each vibration plate by the vibration means.

### DETAILED DESCRIPTION OF THE INVENTION

Hereinafter, preferred embodiments of the present disclosure will be described in detail with reference to the accompanying drawings.

The terms or words used in this specification and claims should not be construed as being limited to ordinary or dictionary meanings, but should be interpreted as meanings and concepts consistent with the technical spirit of the present disclosure on the basis of the principle that an inventor may properly define the concept of terms in order to best describe his or her invention. Therefore, since the embodiment described in this specification and the configuration shown in the drawings are only one of the most preferred embodiments of the present disclosure and do not represent all the technical ideas of the present disclosure, it should be understood that there may be various equivalents and modifications that can replace them at the time of this application.

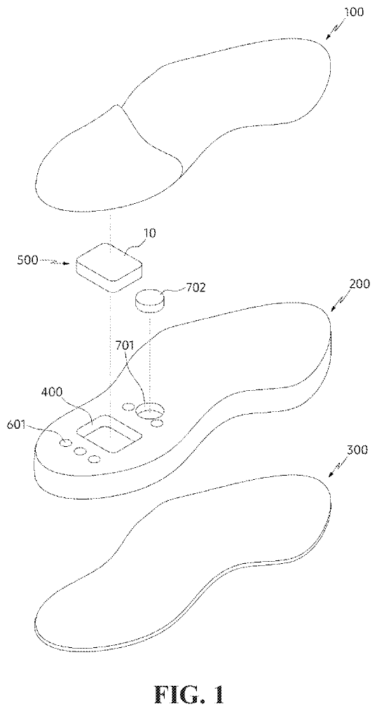

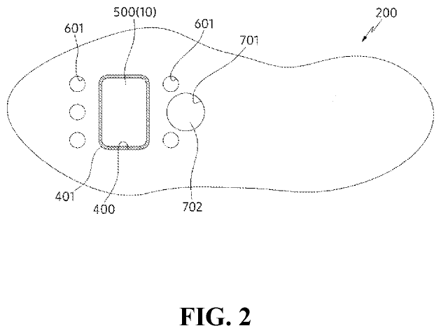

Based on FIG. 1, the outsole side is to be specified as a lower or lower direction, and the midsole side is to be specified as an upper or upper direction. In addition, Based on FIG. 2, the area corresponding to the sole of the wearer's forefoot is specified as front or anterior, and the area corresponding to the sole of the hindfoot is specified as rear or posterior.

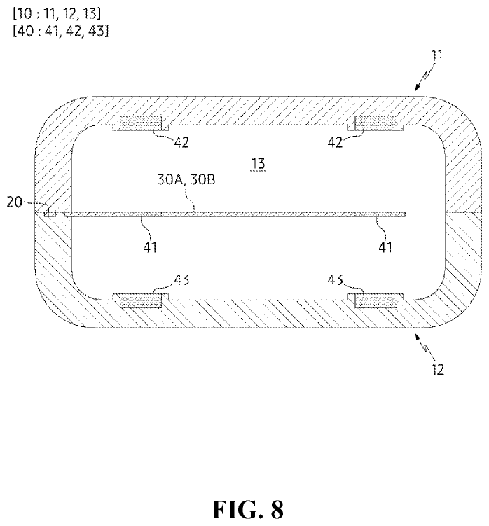

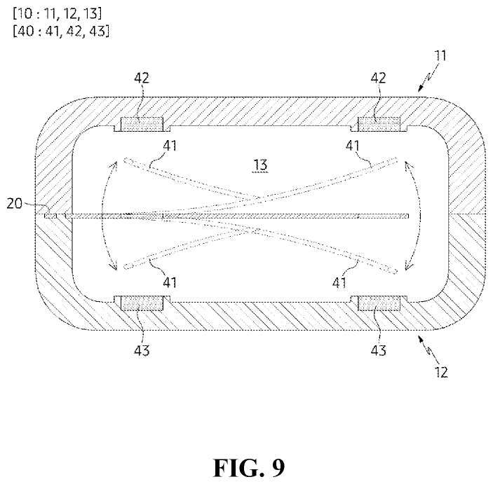

As shown in FIGS. 1 to 9, a health-promoting functional shoe having a function of stimulating a solar plexus point according to the present disclosure consists of an upper 100, a middle sole 200, an outsole 300, a recess 400, a vibration unit 500, and an acupressure unit 600.

Each configuration will be explained.

As shown in FIG. 1, the upper 100 is an upper part structured to cover a wearer's foot, and may be made from a variety of materials such as leather, synthetic leather, or synthetic resin, and may have a structure that covers the entire foot (e.g., men's shoes, etc.), covers only the instep (e.g., slippers or indoor shoes, etc.), or covers both the instep and the heel (e.g., women's shoes, etc.)

As shown in FIGS. 1 and 2, the middle sole 200 is disposed on the bottom surface of the upper 100 and has a structure corresponding to the bottom surface of the upper 100.

As shown in FIG. 1, the outsole 300 is disposed on the bottom surface of the middle sole 200 and has a structure corresponding to the bottom surface of the middle sole 200.

As shown in FIGS. 1 to 3, the recess 400 consists of a space structure that is recessed downward in an area corresponding to the sole of the wearer's forefoot or the sole of the wearer's hindfoot, or both, on the upper surface of the middle sole 200.

At this time, the recess 400 has a space structure having a substantially rectangular shape.

Hereinafter, it is illustrated that the recess 400 is formed only in the area corresponding to the sole of the wearer's forefoot, and will be described based on this, but will not be limited thereto, and it is obvious that the recess 400 may be formed anywhere in the middle sole 400 as long as it is an area where external pressure is transmitted during walking.

As shown in FIGS. 1 to 9, the vibration unit 500 is disposed to be inserted into the recess 400 to generate vibration, and includes a casing 10, a vibration frame 20, a first vibration plate 30A, a second vibration plate 30B, and a vibration means 40.

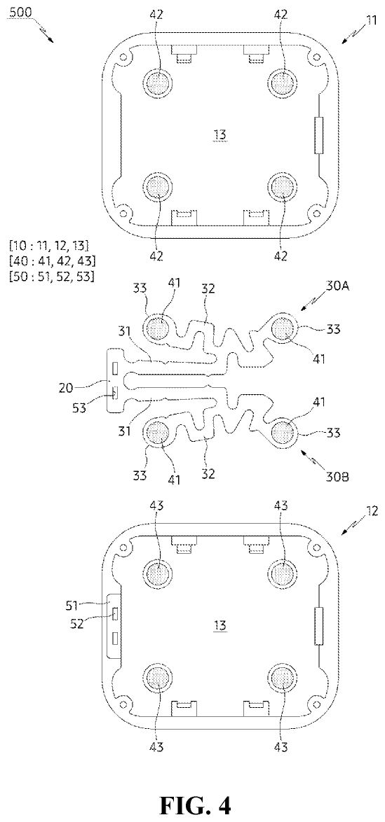

As shown in FIGS. 4, and 7 to 9, the casing 10 has an enclosure structure in which a top housing 11 and a bottom housing 12 are coupled to each other to form a receiving portion 13 therein.

At this time, the top and bottom housings 11 and 12 of the case 10 are structured to face each other, and when the top and bottom housings 11 and 12 of the casing 10 are coupled to each other, the top housing 11 and the bottom housing 12 are mutually coupled so that the receiving portion 13 may be formed therein. The mutual coupling of the top and bottom housings may be made so that they are difficult to separate from each other once coupled by an adhesive or the like, or the top and bottom housings may be detachably coupled through a male and female locking structure or may be coupled to allow assembly and disassembly through bolts or the like.

In addition, the material of the casing 10 is not particularly limited as long as it is capable of transmitting the vibration generated in the receiving portion 13 to the outside, but it is generally preferable to use plastic or rubber rather than metal.

Furthermore, the casing 10 is fixed to the recess 400 by an adhesive layer 401, and the adhesive layer 401 is made of hardened adhesive or adhesive tape so that it is possible to prevent the casing 10 from being separated as much as possible when the wearer's weight is placed on the sole of the foot while walking.

As shown in FIGS. 4 to 9, the vibration frame 20 is interposed between the top and bottom housings 11 and 12 of the casing 10, and has a substantially rectangular structure disposed along a portion of the peripheral area where the top and bottom housings 11 and 12 of the casing 10 come into contact with each other. The vibration frame 20 may be pressed and fixed by the top and bottom housings 11 and 12 coupled to each other, may be fixed by bolts fastened to the top and bottom housings 11 and 12 for mutual coupling. or may be fixed by a separate holding means 50.

As shown in FIGS. 4 to 9, the first vibration plate 30A has the other end thereof connected to the vibration frame 20 and one end thereof disposed in the receiving portion 13 of the casing 10. The first vibration plate 30A is preferably made of an elastic material, preferably thin and long plate shape in particular for high elasticity, and preferably made of copper, zinc, or an alloy thereof.

As shown in FIGS. 4 to 9, the second vibration plate 30B has the other end thereof connected to the vibration frame 20 and one end thereof disposed in the receiving portion 13 of the casing 10, but is arranged side by side with the first vibration plate 30A. Like the first vibration plate 30A, the second vibration plate 30B is preferably made of an elastic material, preferably thin and long plate shape in particular for high elasticity, and preferably made of copper, zinc, or an alloy thereof.

In addition, the second vibration plate 30B has a structure facing the first vibration plate 30A.

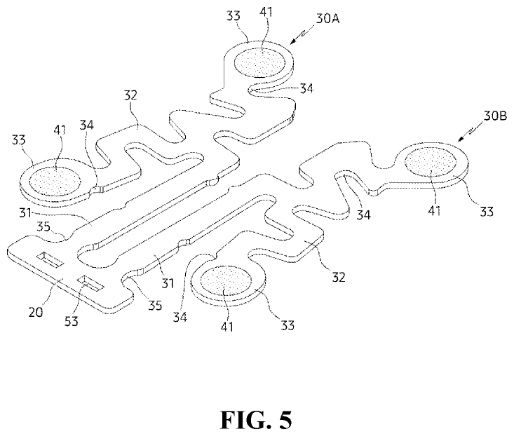

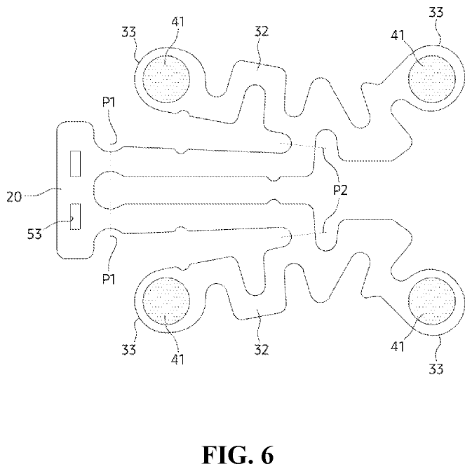

To be specific, as shown in FIGS. 5 and 6, the first and second vibration plates 30A and 30B are composed of supports 31 connected to the vibration frame 20, a pair of branches 32 branching from the end of the support 31, and a pair of discs 33 formed at the ends of each branch 32.

At this time, each branch 32 has a multi-bending structure in which the direction of bending is switched more than n times (n is an integer equal to or greater than 2). In other words, each branch 32 forms an approximate zigzag shape as the bending direction is repeatedly switched back and forth after branching left and right at the end of the support 31.

In addition, as shown in FIGS. 5 and 6, each disc 33 has a circular or elliptical shape when viewed from the top.

Furthermore, as shown in FIG. 6, a U-shaped recess 34 recessed inward is formed at the connection portion between each branch 32 and each disc 33, and this is to facilitate a vertical amplitude motion of the disc 33 as the width thereof narrows due to the recess 34.

In addition, as shown in FIG. 6, a pair of U-shaped neck grooves 35 recessed in opposite directions are formed at the connection portion between the vibration frame 20 and each of the supports 31 of the first and second vibration plates 30A and 30B, and this is to facilitate a vertical amplitude motion of each of the vibration plates 30A and 30B as the width thereof narrows due to the neck grooves 35.

Therefore, when each of the vibration plates 30A and 30B vibrate up and down with respect to the vibration frame 20, the vibration means 40 causes the vertical amplitude motion. In particular, as shown in FIG. 6, each of the vibration plates 30A and 30B performs the vertical amplitude motion based on a first point P1, and at the same time, each branch 32 and each disc 33 perform the vertical amplitude motion based on a second point P2. That is, by performing a large amplitude motion based on the two points P1 and P2 and performing a small amplitude motion based on several bent portions of each branch 32, the vertical amplitude motion is performed in the same manner a butterfly alternately flapping front and hind wings.

Thus, when an external force applied by holding and shaking the casing 10 or walking after installing the casing 10 in the recess 400 is transmitted to the casing 10, each of the vibration plates 30A and 30B moves up and down based on the first point P1. At this time, by the magnetic force of the vibration means 40 and the repulsive force between the respective magnets, each of the vibration plates 30A and 30B performs the vertical amplitude motion, and at the same time, each branch 32 and each disk 33 also perform the vertical amplitude motion based on the second point P2.

The vibration unit 500 of the present disclosure is composed of the support 31 branched into two, the branch 32 branched into two at the end of each support, and the disc 33 formed at each end of the branch, wherein as each branch 32 forms a zigzag shape, the vertical amplitude motion is performed based on the first and second points P1 and P2, and the vertical amplitude motion is also performed based on the bent portion of each branch 32, so that when an external force of the same size is delivered to the casing 10, the vibration may be uniformly transmitted to the outside while the vibration period increases.

As shown in FIGS. 4, and 7 to 9, the vibration means 40 is for vibrating the first and second vibration plates 30A and 30B up and down by magnetic force, and includes: four movable magnets 41, each provided on each disc 33 of the first and second vibration plates 30A and 30B; four top magnets 42 provided in the top housing 11 of the casing 10 and generating repulsive force to each movable magnet 41; and four bottom magnets 43 provided in the bottom housing 12 of the casing 10 and generating repulsive force to each movable magnet 41.

At this time, each movable magnet 41 is a magnet that is not fixed in motion and is able to move along with the vibration of individual discs 33 of each of the vibration plates 30A and 30B, and the types of the top magnets 42 and the bottom magnets 43 are not limited as long as they can have a repulsive relationship with the movable magnets 41, but they are preferably permanent magnets having an N pole and an S pole.

In addition, the top magnets 42 and the bottom magnets 43 may be fixedly disposed in a manner in which they are attached to the top and bottom housings 11 and 12 of the casing 10, respectively, using an adhesive or the like, or may be fixedly disposed in a manner in which arbitrary grooves are dug in the top and bottom housings 11 and 12 of the casing 10 and forcibly inserted and mounted therein.

Accordingly, the vibration plates 30A and 30B vibrate up and down by the magnetic force produced between the movable magnets 41 and the top and bottom magnets 42 and 43 on the upper and lower sides of the movable magnets 41.

Meanwhile, the vibration unit 500 is further provided with the holding means 50.

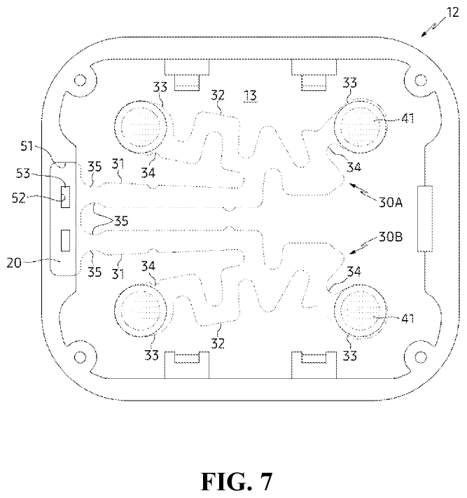

As shown in FIGS. 4 and 7, the holding means 50 is for fixing the vibrating frame 20 to the casing 10, and includes: a space portion 51 formed to be recessed at the end of the top housing 11 or bottom housing 12 in the casing 10 and into which the vibration frame 20 is inserted and seated; two or more posts 52 protruding from the bottom of the space portion 51; and two or more inserts 53 provided to penetrate the vibration frame 20 and fitted into each post 52.

Since the vibration frame 20 is stably fixed to the casing 10 by the holding means 50, when the external force is transmitted to the casing 10, each of the vibration plates 30A and 30B may stably perform vertical amplitude motion with respect to the vibration frame 20.

As shown in FIGS. 1 to 3, the acupressure unit 600 is intended to evenly acupressure the sole of the wearer's foot by external pressure generated when the wearer is walking, and includes: a plurality of receiving space portions 601 formed to be concave downward while being disposed in a form surrounding the vibration unit 500 on the upper surface of the middle sole 200; and a plurality of elastic springs 602 fitted into individual receiving space portions 601.

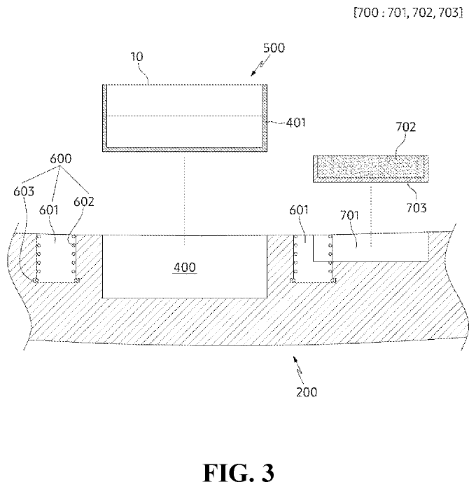

At this time, as shown in FIG. 3, each receiving space portion 601 of the acupressure unit 600 has a snap groove 603 formed along the inner circumferential surface adjacent to the bottom surface of the receiving space portion 601, and as the lower end of the elastic spring 602 is forcibly fitted into the snap groove 603 and fixed, the elastic spring 602 is prevented from being easily separated from the receiving space portion 601 due to external pressure when the wearer walks.

Thus, the elastic spring 602 functions to push the sole of the foot toward the wearer when the sole of the foot is separated from the ground while the wearer is walking.

Meanwhile, the health-promoting functional shoe having a function of stimulating a solar plexus point of the present disclosure may further include a stimulation unit 700.

As shown in FIGS. 1 to 3, the stimulation unit 700 is for stimulating the solar plexus reflex point on the sole of the wearer's foot, and includes: a mounting space portion 701 recessed downward in the area facing the wearer's solar plexus point on the upper surface of the middle sole 200, and a magnet 702 disposed to be inserted into the mounting space portion 701.

At this time, as shown in FIG. 3, the stimulation unit 700 is further provided with a relay 703 made from stainless steel disposed along the area between the mounting space portion 701 and the magnet 702, so that the magnet 702 is more firmly fixed to the mounting space portion 701, and when the diameter of the magnet 702 is different from the diameter of the mounting space portion, the relay 703 having an inner space corresponding to the insufficient diameter may be selected and inserted into the mounting space portion 701.

Accordingly, by means of a magnetic field, the magnet 702 may play a role in clearing energy blockages and facilitating physical activation.

In the above description of the present disclosure, a “health-promoting functional shoe having a function of stimulating a solar plexus point” having a specific shape and structure has been mainly described with reference to the accompanying drawings. However, various modifications and changes to the present disclosure are possible by those skilled in the art, and these modifications and changes should be construed as belonging to the protection scope of the present disclosure.

What is claimed is:

1. A health-promoting functional shoe having a function of stimulating a solar plexus point, the functional shoe comprising:
un upper (100);
a middle sole (200) disposed on a bottom surface of the upper (100);
an outsole (300) disposed on a bottom surface of the middle sole (200);
a recess (400) recessed downward in an area corresponding to a sole of a forefoot of a wearer or a sole of a hindfoot of the wearer, or both, on an upper surface of the middle sole (200);
a vibration unit (500) disposed to be inserted into the recess (400); and
an acupressure unit (600) comprising a plurality of receiving space portions (601) formed to be concave downward while being disposed in a form surrounding the vibration unit (500) on the upper surface of the middle sole (200), and a plurality of elastic springs (602) each fitted into individual receiving space portions (601).

2. The functional shoe of claim 1, wherein each of the receiving space portions (601) of the acupressure unit (600) has a snap groove (603) formed along an inner circumferential surface adjacent to a bottom surface of the each of the receiving space portions 601, and a lower end of each of the elastic springs 602 is forcibly fitted into the snap groove (603) and fixed.

3. The functional shoe of claim 1, further comprising:
a stimulation unit (700) comprising a mounting space portion 701 recessed downward in an area facing the wearer's solar plexus point on the upper surface of the middle sole (200), and a magnet (702) disposed to be inserted into the mounting space portion (701).

4. The functional shoe of claim 3, wherein the stimulation unit (700) further comprises a relay (703) made from stainless steel disposed along an area between the mounting space portion (701) and the magnet (702).

5. The functional shoe of claims 1, wherein the vibration unit (500) comprises:
a casing (10) in which a top housing (11) and a bottom housing (12) are coupled to each other to form a receiving portion 13 therein;
a vibration frame (20) interposed between the top and bottom housings (11) and (12) of the casing (10);
a first vibration plate (30A) having a second end thereof connected to the vibration frame (20) and a first end thereof disposed in the receiving portion (13) of the casing (10);
a second vibration plate (30B) having a second end thereof connected to the vibration frame (20) and a first end thereof disposed in the receiving portion (13) of the casing (10), but having a structure facing the first vibration plate (30A) while being disposed side by side with the first vibration plate (30A); and
a vibration means (40) for vibrating the first and second vibration plates (30A, 30B) up and down by magnetic force.

6. The functional shoe of claim 5, wherein each of the first and second vibration plates (30A, 30B) comprises:
a support (31) connected to the vibration frame (20);
a branch (32) branching from an end of the support (31); and
a pair of discs (33) respectively provided at ends of the branch (32).

7. The functional shoe of claim 6, each branch (32) has a multi-bending structure in which a direction of bending is switched more than n times (n is an integer equal to or greater than 2).
